(19) United States
(12) Patent Application Publication
(10) Pub. No.: US 2009/0062958 A1
(43) Pub. Date: Mar. 5, 2009

(54) AUTONOMOUS MOBILE ROBOT

(76) Inventors: Aaron C. Morris, Pittsburgh, PA (US); William L. Whittaker, Pittsburgh, PA (US); Warren C. Whittaker, Pittsburgh, PA (US)

Correspondence Address: REED SMITH LLP, P.O. BOX 488, PITTSBURGH, PA, 15230-0488, US

(21) Appl. No.: 12/203,082

(22) Filed: Sep. 2, 2008

Related U.S. Application Data
(60) Provisional application No. 60/969,367, filed on Aug. 31, 2007.

(51) Int. Cl. G06F 19/00

(52) U.S. Cl. 700/252; 700/245; 700/254; 700/258; 700/253; 901/1; 901/46; 901/50

(57) ABSTRACT

An autonomous mobile robot. The robot includes a computing device and a modeling module. The modeling module is communicably connected to the computing device, and is configured for autonomously generating a model for each navigation mode of the robot.

### CROSS-REFERENCE TO RELATED APPLICATION

This application claims the benefit of the earlier filing date of U.S. Provisional Patent Application No. 60/969,367 filed on Aug. 31, 2007, the contents of which are hereby incorporated in their entirety.

### BACKGROUND

This application discloses an invention which is related, generally and in various embodiments, to an autonomous mobile robot.

Information from subterranean spaces such as mines, tunnels, caves and sewers has immense environmental, civil, and commercial value. Generally, such subterranean spaces are dangerous, remote, space constrained and generally ill-suited for people to access and labor. In some instances, compact, sensory-tailored robotic systems provide practical solutions to subterranean information-gathering efforts by reaching remote spaces, enduring harsh conditions, and effectively collecting data to a degree that was once not feasible. However, in many other instances, rugged terrain, maze-like tunnels, unanticipated collapses and limited communication persistently oppose robot performance in underground operations.

A variety of circumstances can cause the robot's actual state to differ from the robot's expected state. Such circumstances include physical obstructions, unexpected environmental conditions, obscured sensors, failed sensors, etc. When the robot's actual state differs from the robot's expected state, there is often an uncertainty as to what actions the robot should perform to place the robot into the expected state. Such uncertainty often leads to robot failure, and in many cases, the failed robot is unable to be recovered.

### SUMMARY

In one general respect, this application discloses an autonomous robot. According to various embodiments, the autonomous robot includes a computing device and a modeling module. The modeling module is communicably connected to the computing device, and is configured for autonomously generating a model for each navigation mode of the robot.

In another general respect, this application discloses a method for autonomously modeling a navigation mode of a mobile robot. According to various embodiments, the method includes determining a status of each computational process associated with the navigation mode, logging data associated with each determined status, and automatically generating a model of the navigation mode based on the determined status of each computational process.

In another general respect, this application discloses a method for navigating a subterranean space. According to various embodiments, the method includes receiving a map at the autonomous mobile robot, receiving a sequence of points the autonomous mobile robot is to visit, planning a path from a starting point to an ending point, and receiving an initiation instruction to navigate in a first navigational mode. The method also includes navigating in the first navigational mode from the starting point toward the ending point, determining a status of computational processes during the navigating, comparing each determined status to a corresponding expected status, and selecting a second navigation mode when the determined status of at least one of the computational processes differs from the expected status. The method further includes determining a sequence of computational processes to place the autonomous mobile robot in the second navigation mode, planning a new path to the ending point, and navigating in the second navigation mode to the ending point.

In another general respect, this application discloses a method for exploring a subterranean space. According to various embodiments, the method includes receiving an exploration objective, exploring the subterranean space by navigating in a first navigational mode, and determining a status of computational processes during the navigating. The method also includes comparing each determined status to a corresponding expected status, and returning to a starting point when the determined status of at least one of the computational processes differs from the expected status.

Aspects of the invention may be implemented by a computing device and/or a computer program stored on a computer-readable medium. The computer-readable medium may comprise a disk, a device, and/or a propagated signal.

### BRIEF DESCRIPTION OF THE DRAWINGS

Various embodiments of the invention are described herein in by way of example in conjunction with the following figures, wherein like reference characters designate the same or similar elements.

FIG. 1 illustrates various embodiments of an autonomous mobile robot;

FIG. 2 illustrates various embodiments of a method for autonomously modeling a navigation mode of a mobile robot;

FIG. 3 illustrates various embodiments of a method for navigating a subterranean space; and

FIG. 4 illustrates various embodiments of a method for exploring a subterranean space.

### DETAILED DESCRIPTION

It is to be understood that at least some of the figures and descriptions of the invention have been simplified to illustrate elements that are relevant for a clear understanding of the invention, while eliminating, for purposes of clarity, other elements that those of ordinary skill in the art will appreciate may also comprise a portion of the invention. However, because such elements are well known in the art, and because they do not facilitate a better understanding of the invention, a description of such elements is not provided herein.

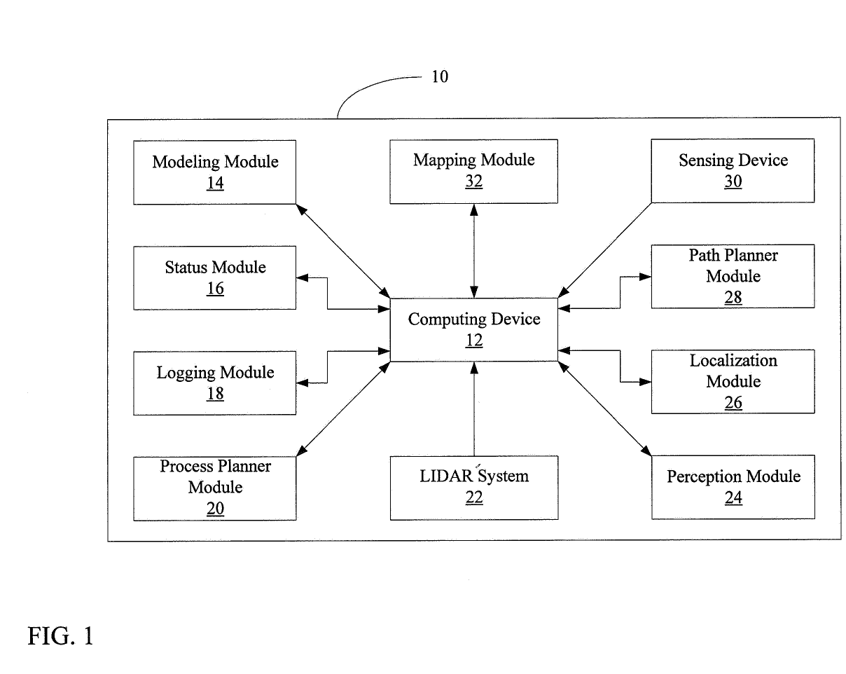

FIG. 1 illustrates various embodiments of an autonomous mobile robot 10. As explained in more detail hereinafter, the robot 10 may be utilized to navigate, explore, map, etc. subterranean spaces. The robot 10 includes a computing device 12, and a modeling module 14 communicably connected to the computing device 12. The computing device 12 may be any suitable type of device (e.g., a processor) configured for processing data and executing instructions. The modeling module 14 is configured for autonomously generating a model for each navigation mode of the robot 10. Navigation modes may include, for example, navigating with one laser, navigating with multiple lasers, navigating with no lasers, etc.). The modeling module 14 may generate any number of such models. For example, for embodiments where the robot 10 has over four thousand different navigation modes, the modeling module 14 may automatically generate over four thousand models. Each model may be in any suitable form. For example, each model may be represented as a map, as a look-up table, etc.

According to various embodiments, the robot 10 also includes a status module 16 communicably connected to the computing device 12. The status module 16 is configured for determining a status for computational processes performed by the computing device 12, comparing each determined status to a corresponding expected status, and deeming an operational state of the robot to be abnormal when at least one determined status is different from the corresponding expected status. The computational processes are processes executed by the computing device 12 which collectively define the functionality of the robot 10. For a given navigation mode, the status for each computational process associated with the navigation mode can be determined in any suitable manner. For example, according to various embodiments, the status of each process may be determined based on whether or not the process is on or off at a given point in time, whether the process is on or off during a given period of time, etc. The on/off nature of each status can be digitally represented as a “one” or a “zero”.

According to various embodiments, the robot 10 also includes a logging module 18 communicably connected to the computing device 12. The logging module 18 is configured for storing data acquired by the status module 16. The stored data may be utilized by the modeling module 14 to autonomously generate the models for the respective navigation modes.

According to various embodiments, the robot 10 also includes a process path planner module 20 communicably connected to the computing device 10. The process path planner module 18 is configured for determining a sequence of computational processes which when executed change the operating state of the robot 10 from one operating state (e.g., an abnormal state) to another operating state (e.g., a normal state). The process path planner module 18 may also be utilized to change the navigation mode of the robot 10.

According to various embodiments, the robot 10 also includes a light detection and ranging (LIDAR) system 22 communicably connected to the computing device 12. The LIDAR system 22 may be any suitable type of LIDAR system. For example, according to various embodiments, the LIDAR system 22 includes one or more rotatable two-dimensional scanners. According to other embodiments, the LIDAR system 22 includes one or more three-dimensional scanners. For embodiments where the robot 10 includes two scanners, one scanner may be positioned on the “front” of the robot 10 and the other scanner may be positioned on the “rear” of the robot 10.

According to various embodiments, the robot 10 also includes a perception module 24 communicably connected to the computing device 12. The perception module 24 is configured for identifying an obstacle based on data acquired by a light detection and ranging system 22.

According to various embodiments, the robot 10 also includes a localization module 26 communicably connected to the computing device 12. The localization module 26 is configured for localizing the robot 10 to a map. The map may be, for example, a map of a subterranean space. The map resides at the robot 10, and may be a representation of a hard copy of a subterranean map.

According to various embodiments, the robot 10 also includes a path planner module 28 communicably connected to the computing device 12. The path planner module 28 is configured for planning a path to be navigated by the robot 10. For example, the path planner module 28 may plan a path which has a starting point and an ending point, and the path includes a subpath from point A to point B, a subpath from point B to point C, a subpath from point C to point D, etc.

According to various embodiments, the robot 10 also includes a sensing device 30 communicably connected to the computing device 12. The sensing device 30 may be any suitable type of sensing device. For example, according to various embodiments, the sensing device 30 may be an optical sensing device, a thermal sensing device, an imaging sensing device, an acoustical sensing device, a gas sensing device, etc. Although only one sensing device 30 is shown in FIG. 1, it is understood that the robot 10 may include any number of sensing devices 30, and the plurality of sensing devices may include any combination of different types of sensing devices.

According to various embodiments, the robot 10 also includes a mapping module 32 communicably connected to the computing device 12. The mapping module 32 is configured for generating a map based on data acquired by the light detection and ranging system 22.

Each of the modules 14, 16, 20, 24, 26, 28, 32 may be implemented in either hardware, firmware, software or combinations thereof. For embodiments utilizing software, the software may utilize any suitable computer language (e.g., C, C++, Java, JavaScript, Visual Basic, VBScript, Delphi) and may be embodied permanently or temporarily in any type of machine, component, physical or virtual equipment, storage medium, or propagated signal capable of delivering instructions to a device. The respective modules 14, 16, 20, 24, 26, 28, 32 (e.g., software application, computer program) may be stored on a computer-readable medium (e.g., disk, device, and/or propagated signal) such that when a computer reads the medium, the functions described herein are performed.

According to various embodiments, each of the modules 14, 16, 20, 24, 26, 28, 32 may be in communication with one another, and may reside at the computing device 12, at other devices within the robot 10, or combinations thereof. For embodiments where the robot 10 includes more than one computing device 12, the modules 14, 16, 20, 24, 26, 28, 32 may be distributed across a plurality of computing devices 12. According to various embodiments, the functionality of the modules 14, 16, 20, 24, 26, 28, 32 may be combined into fewer modules (e.g., a single module).

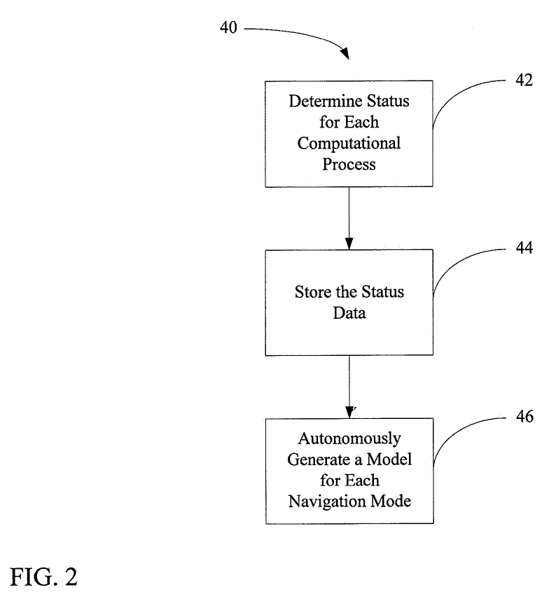

FIG. 2 illustrates various embodiments of a method 40 for modeling a navigation mode of an autonomous mobile robot. The method 40 may be utilized to model a plurality of navigation modes, and may be implemented by the autonomous mobile robot 10 of FIG. 1. For purposes of simplicity, the method 40 will be described in the context of its implementation by the robot 10 of FIG. 1.

The process starts at block 42, where the status module 16 determines a status for each computation process associated with a navigation mode of the robot 10. The status may be determined for a given point in time, for a given period of time, etc. For each computational process associated with the navigation mode, the status may reflect whether computational process is running or not running, on or off, active or inactive, etc. The determined status for each computation process may be digitally represented as a “one” or as a “zero”.

The process advances from block 42 to block 44, where the logging module 18 stores the status data acquired by the status module 16. From block 44, the process advances to block 46, where the model module 14 autonomously generates a model for the navigation mode. According to various embodiments, the model module 14 may autonomously generate the model “offline” when the robot 10 is inactive (e.g., when the robot 10 is not moving). The model may be represented as a map of the computational processes, as a look-up table, etc.

The process described at blocks 42-46 may be repeated any number of times, for any number of different navigation modes of the robot 10. Additionally, the process described at blocks 42-46 may be executed on an ongoing basis. Thus, if the computational processes associated with a given navigation mode change over time for whatever reason, the new log data may be appended to the old log data, thereby allowing the model module 14 to autonomously generate an updated model.

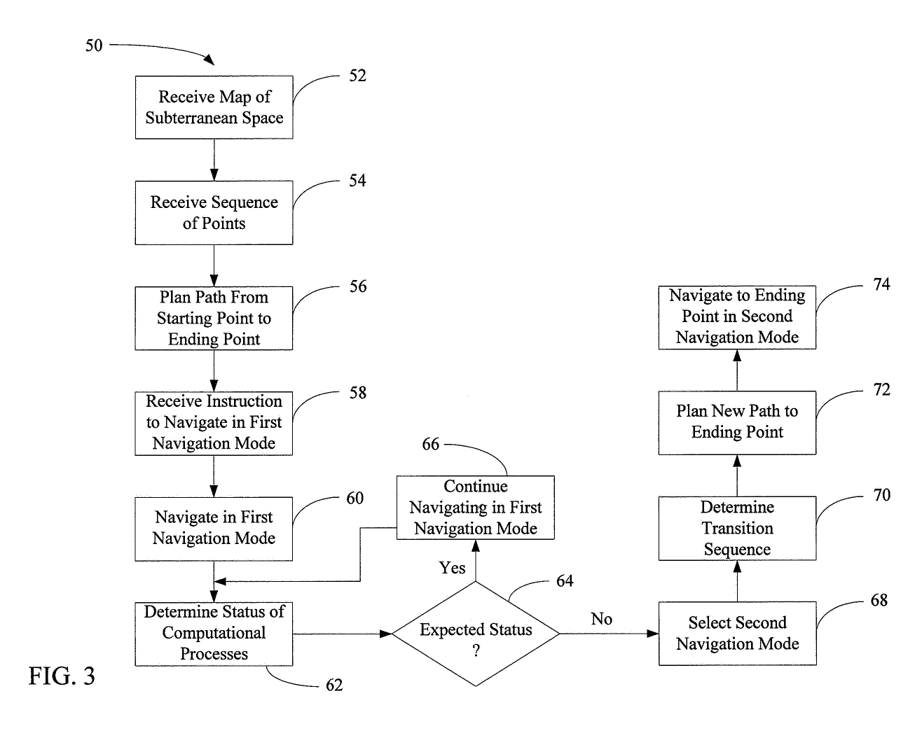

FIG. 3 illustrates various embodiments of a method 50 for navigating a subterranean space. The method 50 may be implemented by the autonomous mobile robot 10 of FIG. 1. For purposes of simplicity, the method 50 will be described in the context of its implementation by the robot 10 of FIG. 1.

Prior to the start of the process, the robot 10 is configured to navigate in a plurality of navigation modes, and already includes a model for each navigation mode. Each model may have been generated for example, by the method 40 of FIG. 2.

The process starts at block 52, where a map representative of the subterranean space is received by the robot 10. The map may be received in any suitable manner (e.g., loaded to the robot 10), and the robot 10 is configured to navigate based on the map. From block 52, the process advances to block 54, where a sequence of points are received by the robot 10. The sequence of points may be received in any suitable manner (e.g., loaded to the robot 10), correspond to locations on the map, and are representative of locations which the robot 10 is to visit in the subterranean space.

From block 54, the process advances to block 56, where the path planner module 28 plans a path from a starting point to an ending point, where the path includes the sequence of points received at block 54. In general, the path planner module 28 may consider a variety of different paths, and will select the most effective path. From block 56, the process advances to block 58, where the robot 10 receives an instruction to navigate in a first navigation mode. The instruction may be received in any suitable manner (e.g., loaded to the robot 10).

From block 58, the process advances to block 60, where the robot 10 begins navigating in the first navigation mode. In general, the robot 10 begins navigating at the starting point of the path and navigates toward the ending point of the path. From block 60, the process advances to block 62, where the status of each computational process associated with the first navigation mode is determined by the status module 16 while the robot 10 is navigating. As described hereinabove, the status information may be stored by the logging module 18. From block 62, the process advances to block 64, where the modeling module 14 compares each determined status to an expected status.

From block 64, the process advances to block 66 or to block 68. If the modeling module 14 determines that the determined status is the same as the expected status for each computational process, the process advances from block 64 to block 66. At block 66, the robot 10 continues to navigate in the first navigation mode. From block 66, as long as the robot 10 has not reached the endpoint of the path, the process returns to block 62. The process described at blocks 62-66 may be repeated any number of times.

If the modeling module 14 determines that the status of at least one of the computational processes is different from the expected status (e.g., the robot 10 has stopped navigating), the process advances from block 64 to block 68. At block 68, the robot 10 selects a second navigation mode to continue navigation toward the endpoint of the path. The robot 10 may select the second navigation mode from any number of potential navigation modes. In general, based on various patterns apparent in the respective models, the robot 10 will select the most appropriate navigation mode. From block 68, the process advances to block 70, where the process planner module 20 determines and executes the sequence of computational process which transitions the robot 10 to the second navigation mode.

From block 70, the process advances to block 72, where the path planner module 28 plans a new path from the existing location of the robot 10 (e.g., between two of the points of the sequence of points) to the ending point of the original path. From block 72, the process advances to block 74, where the robot 10 navigates to the ending point in the second navigation mode.

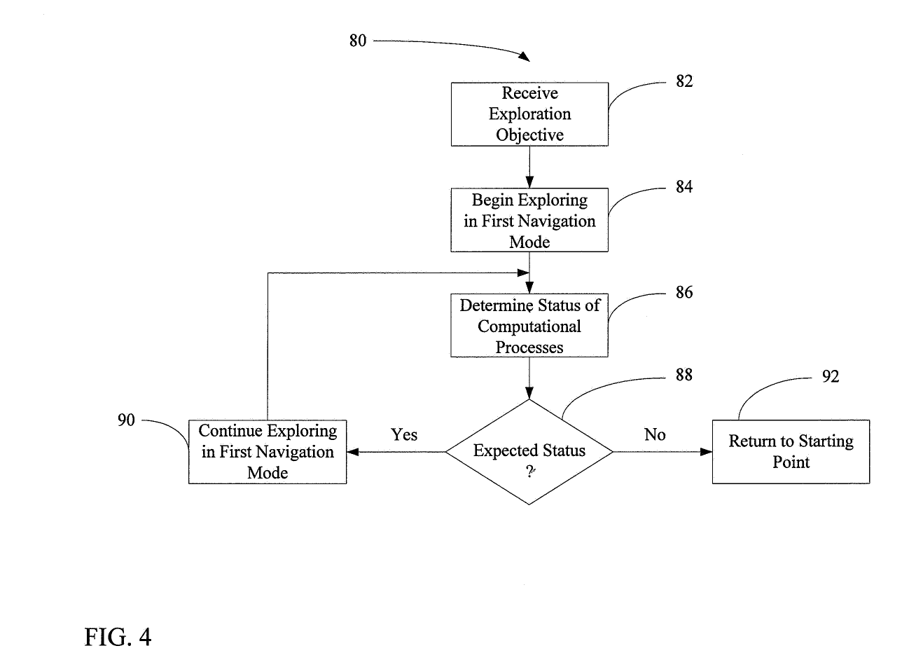

FIG. 4 illustrates various embodiments of a method 80 for exploring a subterranean space. The method may be implemented by the autonomous mobile robot 10 of FIG. 1. For purposes of simplicity, the method 80 will be described in the context of its implementation by the robot 10 of FIG. 1.

Prior to the start of the process, the robot 10 is configured to navigate in a plurality of navigation modes, and already includes a model for each navigation mode. Each model may have been generated for example, by the method 40 of FIG. 2.

The process starts at block 82, where the robot 10 receives an exploration objective. The robot 10 may receive the exploration objective in any suitable manner, and the exploration objective may be any suitable exploration objective. For example, the exploration objective may be to traverse a given distance into a subterranean space, then return to the starting point. From block 82, the process advances to block 84, where the robot 10 begins exploring the subterranean space by navigating in a first navigation mode.

From block 84, the process advances to block 86, where the status of each computational process associated with the first navigation mode is determined by the status module 16 while the robot 10 is exploring. As described hereinabove, the status information may be stored by the logging module 18. From block 86, the process advances to block 88, where the modeling module 14 compares each determined status to an expected status.

From block 88, the process advances to block 90 or to block 92. If the modeling module 14 determines that the determined status is the same as the expected status for each computational process, the process advances from block 88 to block 90. At block 90, the robot 10 continues to explore in the first navigation mode. From block 90, as long as the robot 10 has not traversed the given distance into the subterranean space, the process returns to block 86. The process described at blocks 86-90 may be repeated any number of times. If the robot 10 has successfully traversed the given distance, the robot 10 will return to the starting point. At any time during the robots 10 return to the starting point, if the

If the modeling module 14 determines that the status of at least one of the computational processes is different from the expected status (e.g., the robot 10 has stopped navigating), the process advances from block 88 to block 92. At block 92, the robot 10 returns to the starting point.

According to various embodiments, once the robot 10 has started its return to the starting point, the robot 10 may encounter a condition which forces the robot 10 to cease its return. In such a circumstance, the robot 10 may select a second navigation mode, the process planner module 20 may determine and execute a sequence of computational processes which transition the robot 10 to the second navigation mode, the path planning module 28 may determine a new path to reach the starting point, and the robot 10 may utilize the second navigation mode to return to the starting point via the new path.

Nothing in the above description is meant to limit the invention to any specific materials, geometry, or orientation of elements. Many part/orientation substitutions are contemplated within the scope of the invention and will be apparent to those skilled in the art. The embodiments described herein were presented by way of example only and should not be used to limit the scope of the invention.

Although the invention has been described in terms of particular embodiments in this application, one of ordinary skill in the art, in light of the teachings herein, can generate additional embodiments and modifications without departing from the spirit of, or exceeding the scope of, the claimed invention. For example, various steps of the method 50 or the method 80 may be performed concurrently. Accordingly, it is understood that the drawings and the descriptions herein are proffered only to facilitate comprehension of the invention and should not be construed to limit the scope thereof.

What is claimed is:

1. An autonomous mobile robot, comprising:
a computing device; and
a modeling module communicably connected to the computing device, wherein the modeling module is configured for autonomously generating a model for each navigation mode of the robot.

2. The robot of claim 1, further comprising a status module communicably connected to the computing device, wherein the status module is configured for:
determining a status for computational processes performed by the computing device;
comparing each determined status to a corresponding expected status; and
deeming an operational state of the robot to be abnormal when at least one determined status is different from the corresponding expected status.

3. The robot of claim 2, further comprising a logging module communicably connected to the computing device, wherein the logging module is configured for storing data acquired by the status module.

4. The robot of claim 1, further comprising a process planner module communicably connected to the computing device, wherein the process planner module is configured for determining a sequence of computational processes which when executed change an operating state of the robot from a first state to a second state.

5. The robot of claim 1, further comprising a light detection and ranging system communicably connected to the computing device.

6. The robot of claim 5, wherein the light detection and ranging system comprises a rotatable two-dimensional scanner.

7. The robot of claim 1, further comprising a perception module communicably connected to the computing device, wherein the perception module is configured for identifying an obstacle based on data acquired by a light detection and ranging system communicably connected to the computing device.

8. The robot of claim 1, further comprising a localization module communicably connected to the computing device, wherein the localization module is configured for localizing the robot to a map.

9. The robot of claim 1, further comprising a path planner module communicably connected to the computing device, wherein the path planner module is configured for planning a path to be navigated by the robot.

10. The robot of claim 1, further comprising a sensing device communicably connected to the computing device.

11. The robot of claim 1, further comprising a mapping module communicably connected to the computing device, wherein the mapping module is configured for generating a map based on data acquired by a light detection and ranging system communicably connected to the computing device.

12. A method for modeling a navigation mode of an autonomous mobile robot, the method comprising:
determining a status of each computational process associated with the navigation mode;
logging data associated with each determined status; and
automatically generating a model of the navigation mode based on the determined status of each computational process.

13. The method of claim 12, wherein determining the status of each computational process comprises determining:
which computational processes are in an on state at a point in time; and
which computational processes are in an off state at the point in time.

14. The method of claim 12, wherein automatically generating the model comprises automatically generating a map of the computational processes.

15. The method of claim 14, wherein automatically generating the map comprises automatically generating a look-up table.

16. The method of claim 12, further comprising:
determining a status of each computational process associated with at least one additional navigation mode; and
automatically generating a model of the at least one additional navigation mode based on the determined status of each computational process associated with the at least one additional navigation mode.

17. A method for navigating a subterranean space, the method comprising:
receiving a map at the autonomous mobile robot;
receiving a sequence of points the autonomous mobile robot is to visit;
planning a path from a starting point to an ending point;
receiving an initiation instruction to navigate in a first navigational mode;
navigating in the first navigational mode from the starting point toward the ending point;
determining a status of computational processes during the navigating;
comparing each determined status to a corresponding expected status;
selecting a second navigation mode when the determined status of at least one of the computational processes differs from the expected status;
determining a sequence of computational processes to place the autonomous mobile robot in the second navigation mode;
planning a new path to the ending point; and
navigating in the second navigation mode to the ending point.

18. A method for exploring a subterranean space, the method comprising:
receiving an exploration objective;
exploring the subterranean space by navigating in a first navigational mode;
determining a status of computational processes during the navigating;
comparing each determined status to a corresponding expected status; and
returning to a starting point when the determined status of at least one of the computational processes differs from the expected status.

19. The method of claim 18, further comprising:
selecting a second navigation mode when the determined status of the at least one of the computational processes differs from the expected state after the robot has started to return to the starting point;
determining a sequence of computational processes to place the autonomous mobile robot in the second navigational mode;
planning a new path to the starting point; and
navigating in the second navigation mode to the starting point.
